(19) United States
(12) Patent Application Publication
(10) Pub. No.: US 2026/0024358 A1
(43) Pub. Date: Jan. 22, 2026

(54) DRIVER MONITORING APPARATUS AND MEDIUM

(71) Applicant: HONDA MOTOR CO., LTD., Tokyo (JP)

(72) Inventors: Srinivasa divakar Bhat, Wako-shi (JP); Prateek Garg, Wako-shi (JP); Akira Kanehara, Wako-shi (JP); Masamitsu Tsuchiya, Wako-shi (JP); Ryuji Iwashita, Wako-shi (JP); Mudit Soni, Wako-shi (JP); Surbhi Agrawal, Wako-shi (JP); Tarun Sathesh, Wako-shi (JP)

(73) Assignee: HONDA MOTOR CO., LTD., Tokyo (JP)

(21) Appl. No.: 19/341,028

(22) Filed: Sep. 26, 2025

Related U.S. Application Data
(63) Continuation of application No. PCT/JP2023/013629, filed on Mar. 31, 2023.

(51) Int. Cl. G06V 20/59; B60Q 9/00; G06T 7/50; G06T 7/70; G06V 20/52; G06V 20/56

(52) U.S. Cl. CPC G06V 20/597; B60Q 9/00; G06T 7/50; G06T 7/70; G06V 20/52; G06V 20/56; G06T 2207/30201; G06T 2207/30232; G06T 2207/30252; G06T 2207/30268; G06V 2201/07; G06V 2201/08

(57) ABSTRACT

A driver monitoring apparatus configured to be retrofitted to a vehicle is provided. The driver monitoring apparatus has a camera configured to capture an image including a driver of a vehicle; an output unit. The driving monitoring apparatus performs specifying a gaze direction of the driver from the image captured by the camera; determining whether or not the specified gaze direction is continuously below a preset virtual line for more than a predetermined time; and outputting, by the output unit, a warning to the driver in a case where it is determined that the gaze direction is continuously below the virtual line for more than the predetermined time.

### CROSS-REFERENCE TO RELATED APPLICATION(S)

This application is a continuation of International Patent Application No. PCT/JP2023/013629 filed on Mar. 31, 2023, the entire disclosures of which is incorporated herein by reference.

### BACKGROUND OF THE INVENTION

### Field of the Invention

The present disclosure relates to a driver monitoring apparatus and a medium for monitoring a driver who drives a vehicle, for example.

### Description of the Related Art

There is an apparatus known as a dashcam that is installed in a vehicle and has a function of capturing a video of an area outside the vehicle and recording the latest video for a predetermined time. Some dashcams include a camera for capturing an image of an interior of a vehicle compartment. Japanese Patent Laid-Open No. 2022-111162 discloses a driving situation monitoring apparatus that receives driving situation data including an image of a driver for authentication captured by a dashcam, vehicle information, location information, and acceleration information, and records identification information of the driver and the driving situation data in association with each other.

Japanese Patent Laid-Open No. 2022-111162 further describes that the driving situation monitoring apparatus generates hazardous-event driving data in response to occurrence of an event and transmits warning information to the dashcam.

The driving situation monitoring apparatus described in Japanese Patent Laid-Open No. 2022-111162 monitors a state of a vehicle such as a speed, an acceleration, or a location of the vehicle. Although imaging of the driver is performed, the image is only referred to for identification of the driver and is not used for monitoring of a state of the driver.

### SUMMARY OF THE INVENTION

The present invention contributes to safer operation of a vehicle by monitoring a state of a driver.

According to one aspect of the present disclosure, there is provided a driver monitoring apparatus configured to be retrofitted to a vehicle, the driver monitoring apparatus comprising:
a camera configured to capture an image including a driver of a vehicle;
an output unit;
at least one memory storing instructions; and
at least one processor that is in communication with the at least one memory and that, when executing the instructions, cooperates with the at least one memory to execute processing, the processing including:
   specifying a gaze direction of the driver from the image captured by the camera;
   determining whether or not the specified gaze direction is continuously below a preset virtual line for more than a predetermined time; and
   outputting, by the output unit, a warning to the driver in a case where it is determined that the gaze direction is continuously below the virtual line for more than the predetermined time.

According to the above configuration, a state of the driver is set as a monitoring target, and thus, it is possible to contribute to safer operation of the vehicle.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram illustrating a vehicle according to an embodiment;

FIG. 2 is a block diagram of a dashcam according to the embodiment;

FIG. 3 is a diagram for describing a gaze vector of a driver and a virtual line;

FIG. 4 is a flowchart of virtual line setting processing according to a first embodiment;

FIG. 5 is a flowchart of driver monitoring processing according to the first embodiment;

FIG. 6 is a flowchart of virtual line setting processing according to a second embodiment;

FIG. 7 is a flowchart of (a part of) driver monitoring processing according to a third embodiment;

FIG. 8 is a flowchart of (a part of) driver monitoring processing according to a fourth embodiment;

FIG. 9 is a flowchart of (a part of) driver monitoring processing according to a fifth embodiment; and

FIG. 10 is a flowchart of (a part of) the driver monitoring processing according to the fifth embodiment.

### BRIEF DESCRIPTION OF THE EMBODIMENT

### First Embodiment

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

The present embodiment relates to an information processing apparatus for detecting a movement amount of a moving object to which the information processing apparatus is attached. In the following embodiment, a case where a driver monitoring apparatus is a dashcam attached to a moving object such as a vehicle will be described as an example. However, the driver monitoring apparatus may be another apparatus as long as the driver monitoring apparatus is attached to the moving object and can image areas inside and outside of the moving object. Further, the following embodiment will be described based on an example in which the moving object is, for example, a vehicle. The vehicle is typically a four-wheeled vehicle. However, the present embodiment may also be applied to other types of vehicles as long as the vehicle is driven and operated by an occupant.

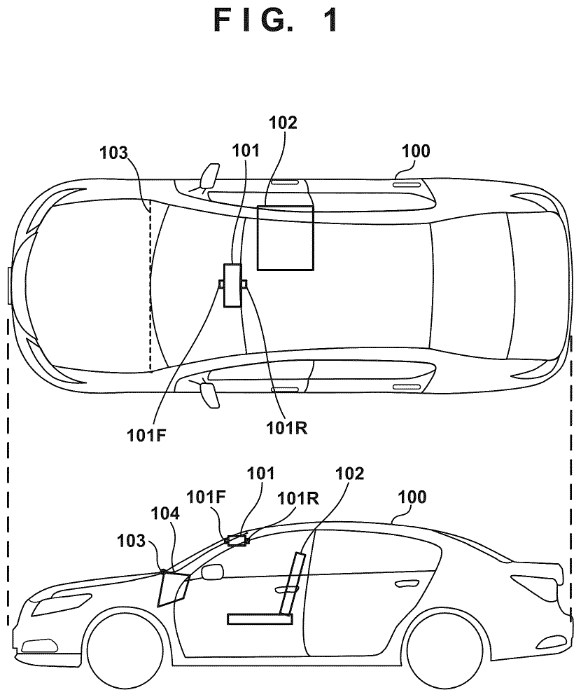

An example of an attachment position of the dashcam will be described with reference to FIG. 1. A dashcam 101 is attached to a vehicle 100. The dashcam 101 is attached at a position on a windshield of the vehicle 100 that does not obstruct a field of view of a driver, the position being near a rear-view mirror, or is attached to the rear-view mirror of the vehicle 100. The attachment position of the dashcam 101 is not limited to such a position, and may be any position as long as an exterior view seen from the vehicle 100 can be imaged.

Although the dashcam 101 can operate on a stand-alone basis, the dashcam 101 may receive power supplied from the vehicle 100. The dashcam 101 includes a vehicle exterior imaging camera 101F that images a scene outside the vehicle, particularly, a scene in front of the vehicle, and a vehicle interior imaging camera 101R that images the inside of the vehicle, particularly, the driver. The vehicle interior imaging camera 101R has a viewing angle at which an image of the face of the driver seated in a driver's seat 102 can be imaged.

As described below, a virtual line 103 (indicated by a dotted line in the drawing) indicating a position of a lower end of the windshield is set in the dashcam 101. Aline where a dashboard 104 provided near a front end of a vehicle compartment of the vehicle 100 and the windshield are in contact with each other may be a curve. However, in the present embodiment, the virtual line 103 is a straight line for simplification of processing and setting. It is a matter of course that the virtual line 103 may have a shape along the actual lower end of the windshield. Since the virtual line 103 is a line serving as a reference for determining that the driver is looking outside (particularly forward) the vehicle if the driver is looking above the virtual line 103, in a case where the lower end of the windshield is a curve as illustrated in FIG. 1, the virtual line 103 may be a straight line extending in a vehicle width direction from a reference point on the curve that is closest to the front of the vehicle.

### Configuration Example of Drive Recorder

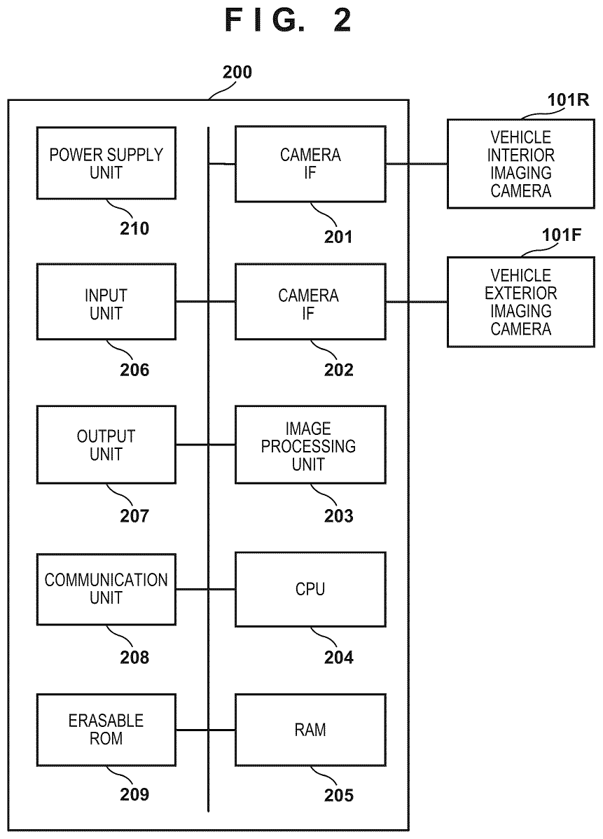

FIG. 2 illustrates an example of a control configuration of the dashcam 101 according to the embodiment. The dashcam is retrofitted to the vehicle, and there is no need for an external signal to be input thereto. However, power supply to the dashcam 101 depends on the vehicle 100. In addition, a device mounted on the vehicle 100 or another device may also be able to be used as a user interface. It is a matter of course that the dashcam 101 may include an input/output device for providing the user interface. In the present embodiment, the driver is monitored by the dashcam. In this regard, the dashcam 101 may be referred to as the driver monitoring apparatus. Alternatively, the dashcam 101 may be referred to as a driving assistance apparatus.

In FIG. 2, the dashcam 101 includes a control unit 200, the vehicle interior imaging camera 101R, and the vehicle exterior imaging camera 101F. The cameras may be referred to as an imaging unit or an image acquisition unit. Camera interfaces (IF) 201 and 202 are signal interfaces with the vehicle interior imaging camera 101R and the vehicle exterior imaging camera 101F, respectively. Each camera captures a video (moving image) at a predetermined frame rate of, for example, 29 frames per second (fps). The captured image is subjected to image processing by an image processing unit 203, and further subjected to necessary processing by a central processing unit (CPU) 204. Then, the captured image is stored as a video file in an erasable read-only memory (ROM) 209. The video file includes a video of a predetermined duration, for example, about 30 seconds to 60 seconds. When recording for the predetermined duration is completed, a new video file is recorded. There are at least two video files. When there is no free space in the erasable ROM 209, the oldest video file is erased to secure a free space, and a new video file is recorded therein. In addition, the captured video can be referred to for each frame, and in this example, the frame may be particularly referred to as an image. Examples of processing that can be performed by the image processing unit 203 may include processing of converting an image obtained by imaging a target into an image of the target as viewed from a different angle, such as projective transformation. In addition, the CPU 204 executes a program of a procedure described below and incorporates a timer (not illustrated) therein.

In order to function as the dashcam, the dashcam also includes an acceleration sensor and the like, and performs control such that, for example, the recording of a video file is stopped when an acceleration exceeding a predetermined value is detected. However, in order to describe the dashcam by focusing on a driving assistance function thereof, description of the function as the dashcam and description of the device are omitted in the present embodiment.

A communication unit 208 provides a wire or wireless communication function. For example, in order to output a warning described below, the dashcam may be connected to a smartphone or the like via the communication unit 208 such that a warning is output to the smartphone or the like. It is a matter of course that it is also possible to perform communication for other purposes.

An input unit 206 and an output unit 207 each include an input/output unit as a user interface. The input/output unit may be implemented by, for example, a touchscreen included in an operation unit. Alternatively, there may be provided an interface for connection to a display audio device provided in the vehicle 100. Further, an interface for connection to a mobile terminal may be provided. A random access memory (RAM) 205 is used as a data memory necessary for an operation of the CPU 204 and the image processing unit 203 and as a memory for storing a program to be executed by the CPU 204. A power supply unit 210 is connected to a power supply provided from the vehicle 100, and provides power suitable for the dashcam.

### Outline of Driver Monitoring

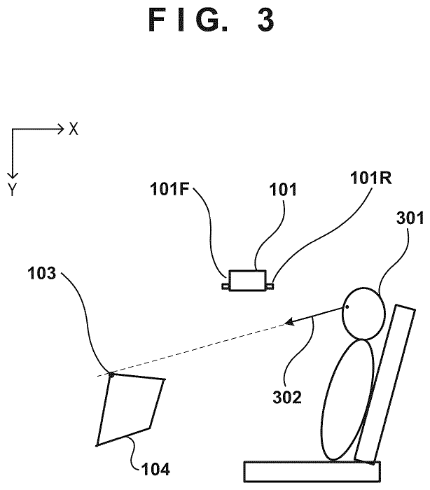

FIG. 3 is a diagram for describing a gaze vector of the driver to be monitored and the virtual line in the present embodiment and other embodiments. The reference numerals described in FIG. 1 will not be described here. A driver 301 seated in the driver's seat 102 looks an area in front of the vehicle and the surroundings through the windshield while traveling forward. However, looking below the area, specifically, a lower portion of the lower end of the windshield, is not common during traveling, except for briefly glancing at a speedometer or the like.

Therefore, the dashcam 101 of the present embodiment images the face of the driver 301 using the vehicle interior imaging camera 101R, and specifies a gaze vector 302 indicating a direction in which the driver is looking. The gaze vector 302 is a vector indicating a gaze direction with one of the left and right eyes of the driver as a start point. A magnitude thereof may be an appropriate predetermined value. Which one of the left and right eyes is set as the start point may be determined in advance, or if only one of the left and right eyes can be recognized, the one that can be recognized may be set as the start point. If an extension line (indicated by a dotted line in the drawing) of the gaze vector 302 is above the virtual line 103 indicating the lower end of the windshield, it can be estimated that the driver is looking outside, and if the extension line is below the virtual line 103, it can be estimated that there is a possibility that the driver is not looking outside and is distracted.

For the above estimation, one three-dimensional coordinate system is set in the dashcam 101. The three-dimensional coordinate system is referred to as camera coordinates or a camera coordinate system. In the camera coordinate system, for example, an origin thereof is an installation position of the dashcam 101, an X axis is set along an optical axis of the vehicle interior imaging camera 101R, a Y axis is set toward a vehicle lower side, and a Z axis is set along the vehicle width direction. A position of the driver 301 and a position of the virtual line 103 can be specified in the coordinate system. Desirably, the dashcam 101 is attached such that an optical axis of the vehicle exterior imaging camera 101F is parallel to a surface (ground) on which the vehicle 100 travels and is aligned with a straight traveling direction of the vehicle 100. In addition, the optical axis of the vehicle interior imaging camera 101R is coaxial with or parallel to the optical axis of the vehicle exterior imaging camera 101F.

Further, an attachment position of the dashcam 101 with respect to the vehicle is set at the time of attachment. The attachment position may include, for example, a height of the position of the dashcam 101 from the ground and an offset with respect to a center line in the vehicle width direction. The reason why the camera is installed as described above is that the camera coordinate system and a coordinate system of the vehicle can be easily converted only by parallel movement. Therefore, the camera may be installed in any manner as long as the camera can image the inside and the outside of the vehicle. In this case, parameters necessary for maintaining compatibility between the coordinate system of the camera and the coordinate system of the vehicle are set. Furthermore, in order to estimate a distance to the driver, a distance to the center of the driver's seat from the center line of the vehicle (a distance in a depth direction in FIG. 3) may be set in the vehicle width direction.

### Virtual Line Setting Processing

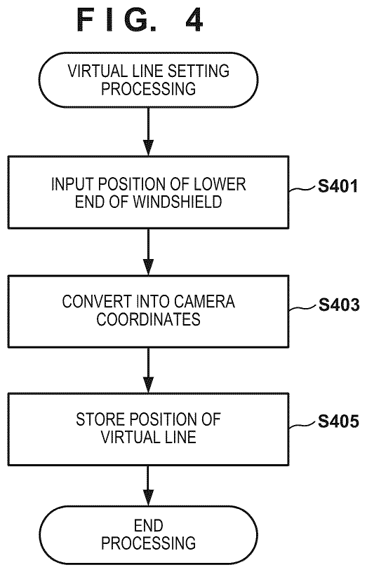

Here, processing for setting the virtual line 103 will be described. Processing described with reference to FIG. 4 and the subsequent drawings is executed by the CPU 204, or may be executed by the image processing unit 203. In any case, an entity responsible for the processing may be referred to as a processing unit. Further, the control unit 200 may be referred to as a processing unit.

In FIG. 4, an operator first inputs a position of the lower end of the windshield via the input unit 206 (S401). The position may be, for example, a height and a depth from the ground. The depth may be, for example, a distance from an attachment position of the camera along the X axis. In a case where the windshield has a quadratic curved surface or a cubic surface and the lower end has a curved shape, the height and the depth may be input with reference to a foremost end. In this case, the virtual line 103 to be set is a straight line that passes through the input position and is parallel to the Z axis.

Next, the input position is converted into the camera coordinate system (S403). Since the attachment position of the dashcam 101 is set and stored at the time of installation, the input position is converted such that the attachment position serves as the origin. In a case where the height along the X axis and the depth along the Y axis are input with reference to the position of the camera, conversion into the camera coordinates as illustrated in FIG. 3 can be performed only by determining a sign of the depth. It is assumed that the units of length are unified based on a predetermined unit such as a centimeter or a millimeter.

Coordinates of the position of the virtual line obtained in the last step S403 are written and stored in the erasable ROM 209 (S405). The coordinates of the virtual line set here are (Xv, Yv). In the case of division using the virtual line (Xv, Yv), if a Y-coordinate value of an intersection point between the extension line of the gaze vector 302 and a Y-Z plane at an X-coordinate value of Xv exceeds Yv, it can be estimated that the gaze vector 302 indicates a gaze that is directed forward through the windshield. On the other hand, if the Y-coordinate value of the intersection point is equal to or less than Yv, it can be estimated that the gaze vector 302 indicates a gaze that is not directed forward but is directed toward the dashboard 104 or an area below the dashboard 104.

### Driver Monitoring Processing

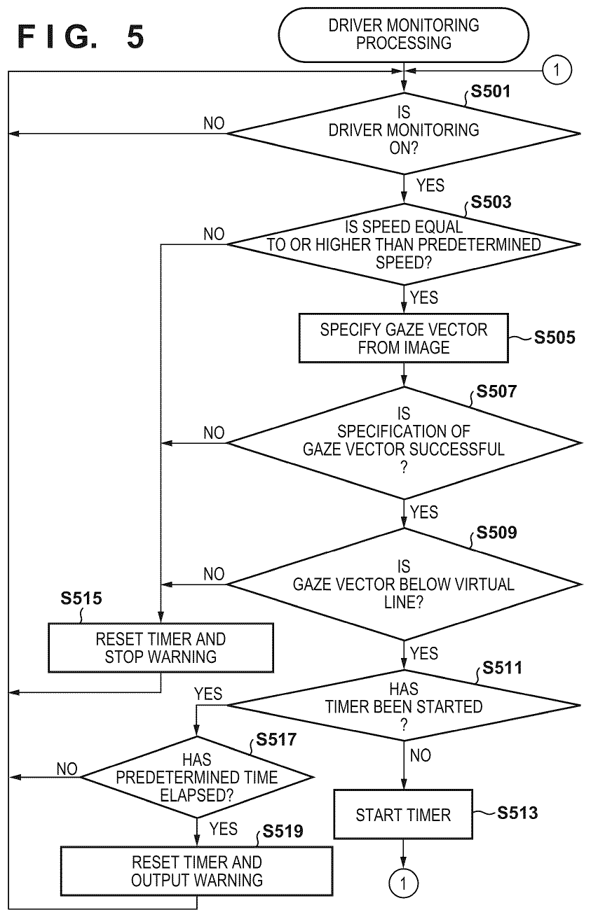

Once the virtual line 103 is set by the procedure of FIG. 4, the driver is monitored with reference to the virtual line. An example of the procedure is illustrated in FIG. 5. The processing of FIG. 5 is performed in a loop and repeated without termination. However, the processing may be interrupted by an interrupt or the like, or may be executed in parallel with other processing. The processing of FIG. 5 may also be executed by the CPU 204. The processing may be started, for example, when the power supply of the vehicle 100 is turned on and the power is also supplied to the dashcam 101. Alternatively, the processing may be started when traveling of the vehicle is detected from the image captured by the vehicle exterior imaging camera 101F.

First, it is determined whether or not a driver monitoring setting is on (S501). The setting is a setting stored in the ROM 209 or the like, and driver monitoring is performed if the setting is on, and the driver monitoring is not performed when the setting is off. In step S501, if the monitoring setting is off, the processing loops at step S501. However, the processing of FIG. 5 may be stopped and may be started after the monitoring setting is turned on. For example, the driver may be able to set on or off of the driver monitoring setting via the input unit 206.

In a case where it is determined that the driver monitoring setting is on, it is determined whether or not a current speed is equal to or higher than a predetermined speed (S503). If the current speed is lower than the predetermined speed, the monitoring is stopped. If the current speed is equal to or higher than the predetermined speed, the processing branches to step S505. If the dashcam 101 does not have a function of measuring the speed (or even if the dashcam 101 has the function), step S503 may be skipped. In this case, if the driver monitoring setting is on, the processing branches to step S505. The speed may be estimated by the dashcam 101 as follows, for example. If a grounding point between a target object appearing in the video captured by the vehicle exterior imaging camera 101F and the ground is moved into a screen, a distance from the dashcam 101 to the grounding point can be estimated based on an image height of the grounding point in a frame. Therefore, it is possible to estimate the speed of the vehicle by specifying a corresponding stationary target object such as a building or a white line on a road surface in a plurality of frames and dividing a difference in distance to the target object between the frames by a time difference between the frames.

Next, the gaze vector 302 of the driver 301 is specified from the image captured by the vehicle interior imaging camera 101R (S505). The gaze vector 302 may be a vector on an X-Y plane as illustrated in FIG. 3, and does not have to have a Z component. An existing method may be used as a method of specifying the gaze vector. For example, the eyes of the driver are recognized from the image. For this purpose, pattern matching may be used, or a trained model obtained by machine learning using a feature extracted from the image as an input may be used for recognition. Once the positions of the eyes are recognized, a direction of the face is specified. The direction of the face may be specified based on a distortion of an inverse triangle formed by both eyes and the mouth using the positions of both eyes or/and a position of the mouth as an input. The direction of the face specified in this manner may be specified as a direction of the gaze vector. The magnitude of the gaze vector may be appropriate. This process may be performed by machine learning.

Further, a direction in which the eyes are directed may be specified, and the gaze vector may be specified by combining the specified direction with the direction of the face. For this purpose, for example, once the direction of the face is successfully specified, image conversion is performed so as to be directed straight at the face. In the image after the conversion, a portion other than an eyeball near the eye (for example, an inner or outer corner of the eye) is specified as a reference position, and the gaze is specified from a positional relationship between a position of the pupil or the iris of the eye and the reference position (which is referred to as a provisional gaze vector). The positional relationship between the position of the pupil or the iris of the eye and the reference position and the provisional gaze vector may be associated with each other in advance and then stored, and the provisional gaze vector may be specified with reference to the association. Since the provisional gaze vector is a vector when being directed straight at the face of the driver, the provisional gaze vector is converted so as to be inclined according to the direction of the face to thereby obtain the target gaze vector 302.

Although the gaze vector 302 from the eye as the start point can be determined as described above, only a vector based on the position of the eye can be determined, and thus, it is necessary to convert the gaze vector 302 into the camera coordinate system. For this purpose, the position of the eye as the start point is determined by the camera coordinates. Since the dashcam 101 is fixed to the vehicle, a direction of the eye with respect to the vehicle interior imaging camera 101R can be specified if the eye can be specified from the captured image. If the vehicle interior imaging camera 101R is a stereo camera, the distance can be specified from parallax, so that the position of the eye can be specified by polar coordinates with the camera as the origin.

On the other hand, if the vehicle interior imaging camera 101R is a monocular camera, the distance is estimated from the specified direction of the eye. Therefore, for example, it is assumed that a value of a Z component of the position of the driver (the position of the eye) in the camera coordinate system is determined by the attachment position of the camera and a seat arrangement of the vehicle. It has been described that, when attaching the dashcam 101, for example, the height of the position of the dashcam 101 from the ground and an offset with respect to the center line of the vehicle are set. In addition, in a case where the vehicle interior imaging camera 101R is a monocular camera, an offset to the center of the driver's seat 102 in the width direction (Z direction) with respect to the center line of the vehicle may be further set. As a result, a value (Zdrv) of a Z component of the center line of the driver's seat 102 in the width direction in the camera coordinate system can be specified. It is assumed that the eye of the driver is positioned in a plane (referred to as a driver's seat center plane) parallel to the X-Y plane specified by the value Zdrv of the Z component. If a straight line from the camera toward the eye of the driver is specified from the image on such an assumption, a distance to an intersection point between the straight line and the driver's seat center plane is a distance from the camera to the eye. Once the direction of the eye and the distance to the eye are successfully specified, a position of a polar coordinate system thereof can be converted into the camera coordinate system to obtain the start point of the gaze vector 302. It is a matter of course that this method is an example, and other methods may be adopted.

Next, whether or not the specification of the gaze vector is successful is determined (S507). If the face of the driver or the direction thereof cannot be specified, it may be determined that the specification of the gaze vector has failed. In addition, in a case where the direction of the face can be specified but the provisional gaze vector cannot be specified, the gaze vector 302 may be specified based on the direction of the face, and it may be assumed that the specification of the gaze vector is successful.

If the gaze vector is successfully specified, it is determined whether or not the gaze vector 302 is below the virtual line (S509). That is, it is determined whether or not the extension line of the gaze vector 302 is below the virtual line 103. The determination may be performed as described above. That is, when the virtual line (Xv, Yv) is set, the intersection point between the extension line of the gaze vector 302 and the Y-Z plane at the X-coordinate value of Xv is obtained. If the Y-coordinate value of the intersection point is equal to or less than Yv, it can be estimated that the gaze vector 302 is below the virtual line 103, that is, the driver 301 is not looking forward but is looking at the dashboard 104 or an area below the dashboard 104.

In a case where it is determined that the extension line of the gaze vector 302 passes below the virtual line 103, it is determined whether or not the timer has been started (S511), and if the timer has not been started, the timer is started (S513). The timer is incorporated in, for example, the CPU 204, and is a timer for measuring a predetermined time in order to determine whether or not the driver continuously directs his/her gaze below the preset virtual line for more than the predetermined time.

On the other hand, in a case where it is determined that the timer has been started, it is determined whether or not the predetermined time has elapsed (S517). Here, the predetermined time may be set when the timer is started, and an interrupt may occur when the timer expires, or whether or not the predetermined time has been reached may be monitored at regular time intervals. In the present embodiment, since the monitoring is performed in a loop process, the latter method may be used. In particular, in the latter method, the setting of the predetermined time can be changed after the timer is started, it is particularly suitable for a fifth embodiment and the like described below. The predetermined time may also be referred to as a reference time.

If the predetermined time has elapsed, the timer is reset, and the warning is output from the output unit 207 (S519). The warning may be a voice, an indicator, or the like. The warning may be output from a main body of the dashcam 101 or may be output from another device such as a mobile terminal. It is assumed that the timer is stopped by resetting.

In a case where it is determined in step S503 that the speed does not exceed the predetermined speed, in a case where it is determined in step S507 that the specification of the gaze vector has failed, or in a case where it is determined in step S509 that the extension of the gaze vector is on the virtual line, the processing branches to step S515. In step S515, the timer is reset, and the output of the warning is stopped. The warning may be stopped even when the warning is not being output, or the warning may be stopped only when the warning is being output. In FIG. 5, when the driver monitoring setting is turned off in a state in which the warning is output in step S519, the warning remains output. However, in preparation for such a case, the processing may branch to step S515 in a case where it is determined that the driver monitoring setting is off.

### Advantageous Effects of Present Embodiment

In this manner, the dashcam 101 can be used to monitor the driver, in particular, to monitor whether or not the driver is looking forward. In a case where the driver is looking below the virtual line for more than a predetermined time, the driver may be staring at an instrument panel, focusing on an operation of the instrument panel, or operating a mobile terminal. Such a situation can be determined by the dashcam that can be retrofitted, and a warning can be issued to the driver if there is a possibility that the driver is distracted to thereby prompt the driver to concentrate on driving.

### Second Embodiment

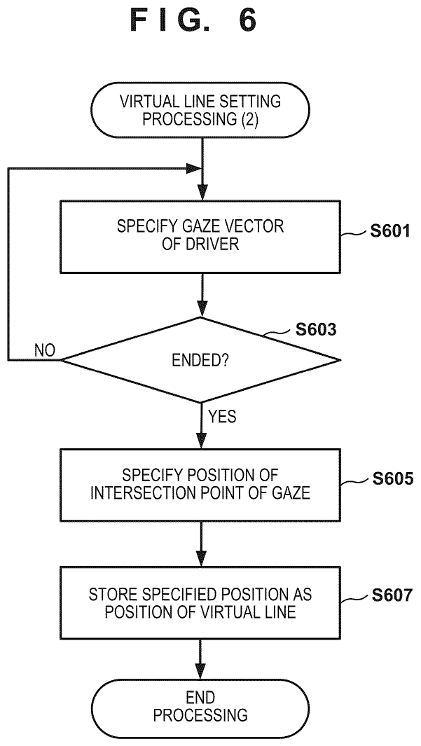

In the present embodiment, instead of the procedure of FIG. 4, a procedure of FIG. 6 will be described as a procedure for setting a virtual line. The second embodiment is similar to the first embodiment except that FIG. 4 is changed to FIG. 6. In the present embodiment, instead of having an operator directly input a position of the virtual line, a position of a virtual line 103 is set based on a gaze vector when a driver looks at the virtual line 103.

In FIG. 6, first, a gaze vector of a driver 301 seated in a driver's seat 102 is specified (S601). The gaze vector may be a vector on an X-Y plane, and a value in a Z direction does not need to be specified. At this time, the driver looks at a position where the virtual line 103 at a lower end of a windshield is set. Then, it is determined whether or not the specification of the gaze vector has ended (S603). The term “end” as used herein means that a plurality of times of trial have ended. In the plurality of times of trial, it is desirable that the driver changes a height of the face by, for example, changing a depth of seating in each trial. The term “a plurality of times” means at least two times.

Once the specification of the gaze vector performed a plurality of times has ended, an intersection point between extension lines of the gaze vectors is specified (S605). A value of a position (X, Y) of the specified intersection point is stored as a setting value of the virtual line (Xv, Yv) (S607).

### Advantageous Effects of Present Embodiment

As described above, the virtual line can be set without inputting a numerical value or the like. Such a method can also be applied to a third embodiment and subsequent embodiments.

### Third Embodiment

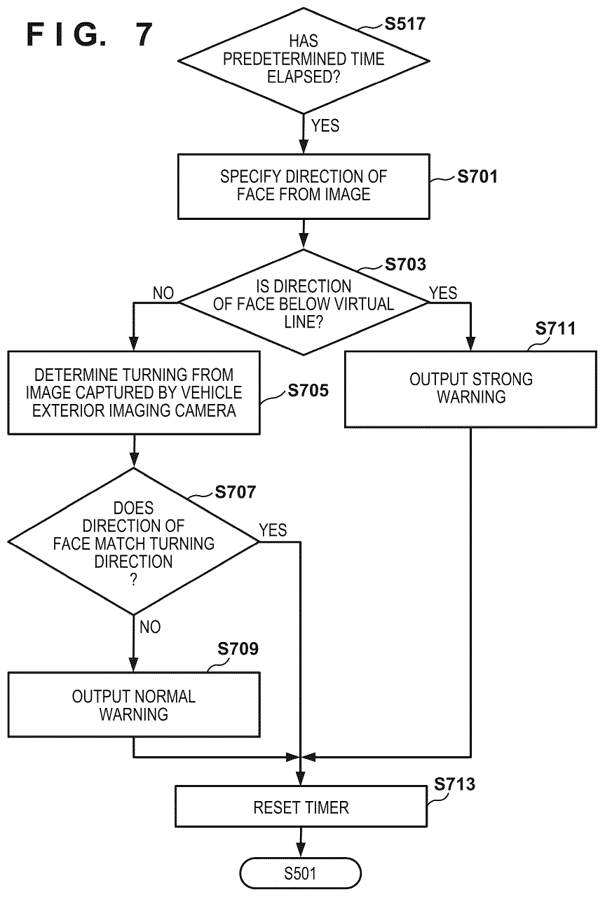

FIG. 7 illustrates a driver monitoring procedure according to the third embodiment. FIG. 7 illustrates a procedure executed instead of step S517 in a case where it is determined in step S519 of FIG. 5 that a predetermined time has elapsed. Therefore, description of the same steps as those in FIG. 5 is omitted. In the present embodiment, a direction of the face is specified, and a level of warning varies between a case where only the eye is directed below a virtual line and a case where the face is also directed below the virtual line.

In FIG. 7, in a case where it is determined in step S517 that the predetermined time has elapsed, the direction of the face is specified from an image captured by a vehicle interior imaging camera 101R (S701). This process may be performed as described in step S505 of FIG. 5. However, in step S701, the direction of the face is specified in three dimensions including a Z component.

Next, it is determined whether or not the face is directed to an area below a virtual line 103 (S703). For example, a vector of the direction of the face is generated instead of a gaze vector 302, and an intersection point between an extension line of the vector and a Y-Z plane at an X-coordinate value of Xv is obtained. If a Y-coordinate value of the intersection point is equal to or less than Yv, it can be estimated that the face is directed below the virtual line 103. In the determination, the Z component of the direction of the face does not have to be used.

In a case where it is determined that the face is not directed below the virtual line 103, turning of the vehicle is determined based on an image captured by a vehicle exterior imaging camera 101F (S705). For this purpose, for example, a motion vector of a corresponding target object may be detected between a plurality of frames, and if an average direction is any one of a left direction and a right direction, it may be determined that the vehicle is turning in the direction. At this time, the specified turning direction is stored. The turning direction can be indicated by, for example, a sign (positive or negative) of a value obtained by subtracting a Z-coordinate value of an end point from a Z-coordinate value of a start point of the motion vector. Alternatively, the start point and the end point may be reversed.

Next, it is determined whether or not the stored turning direction matches the direction of the face (S707). The determination may be performed based on whether or not the sign indicating the turning direction stored in step S705 matches a sign of a value obtained by subtracting a Z component of an end point from a Z component of a start point of the vector indicating the direction of the face. If the signs match each other, it can be determined that the turning direction and the direction of the face match each other.

In a case where it is determined in step S707 that the turning direction and the direction of the face do not match each other, it is determined that a driver is looking below the virtual line only by moving the eye, and a normal warning is output (S709). In a case where it is determined that the turning direction and the direction of the face match each other, it can be determined that the face is directed to the turning direction. Therefore, a warning is not issued even if it is determined that the gaze vector is directed below the virtual line. In a case where it is determined in step S703 that the face is directed below the virtual line, a warning stronger than the normal warning is output (S711). This is because it is estimated that the driver is severely distracted. The last timer is reset, and the processing branches to step S501 (S713). The warning stronger than the normal warning is, for example, a loud sound or an intermittent sound in the case of a voice, and may be an indicator with a more conspicuous color or blinking in the case of an indicator.

### Advantageous Effects of Present Embodiment

In the present embodiment, it is possible to warn the driver more strongly in a case where not only the gaze but also the face is directed below the virtual line according to the above procedure. In addition, by not issuing a warning in a case where it can be estimated that the driver is looking at the turning direction, it is possible to reduce a trouble of the driver caused by issuing an unnecessary warning.

### Fourth Embodiment

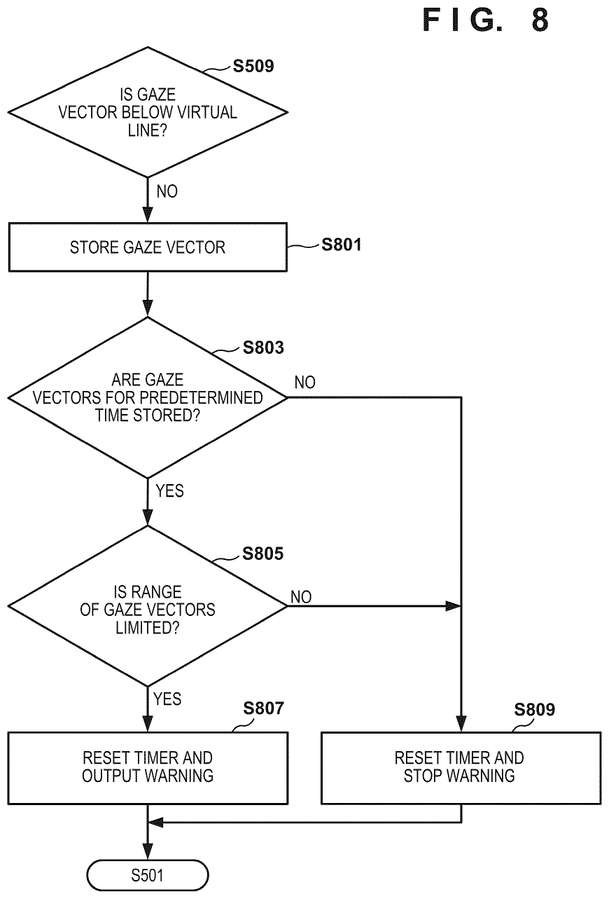

Next, an example in which a warning is issued to the driver not only in a case where a driver is looking below a windshield but also in a case where a gaze of the driver is within a certain range for more than a predetermined time, that is, in a case where the gaze is fixed, will be described. FIG. 8 is an example of a procedure executed by a CPU 204 in this case. FIG. 8 illustrates a case where it is determined in step S509 of FIG. 5 that an extension line of a gaze vector 302 is not below a virtual line, and processing other than processing in this case is similar to that of the first embodiment. Description of parts similar to those of the first embodiment will be omitted.

In FIG. 8, in a case where it is determined in step S509 that the extension line of the gaze vector 302 is not below the virtual line, a value of the gaze vector is stored (S801). A location where the gaze vector is stored may be a RAM 205, and a storage capacity enough to store a predetermined amount of gaze vectors is secured for this purpose. Next, it is determined whether or not the gaze vectors for the predetermined time are stored (S803). The gaze vectors for the predetermined time are gaze vectors specified within the predetermined time, but when a data amount is excessively large, not all but some of the gaze vectors may be periodically sampled and stored in step S801. In step S801, if the amount of stored gaze vectors exceeds the amount for the predetermined time, the oldest gaze vector may be erased and a new gaze vector may be stored.

In a case where it is determined that the gaze vectors for the predetermined time have been stored, it is determined whether or not a range of the stored gaze vectors, that is, end points of the gaze vectors fall within a predetermined range (S805). A minimum region including the end points of all the stored gaze vectors may be specified, and it may be determined that the range of the gaze vectors is limited if a maximum diameter of the region is equal to or smaller than a threshold. Alternatively, more simply, the range of the gaze vectors may be determined to be limited if a difference between a maximum Z component and a minimum Z component and a difference between a maximum Y component and a minimum Y component among all the stored gaze vectors are equal to or less than thresholds. In this case, the threshold for the Z component and the threshold for the Y component may be different from each other.

In a case where it is determined that the end points of the gaze vectors fall within the predetermined range, a timer is reset to output a warning (S807). Otherwise, the timer is reset to stop the warning (S809).

### Advantageous Effects of Present Embodiment

According to the above procedure, in a case where it is determined that the gaze of the driver is fixed to something, a warning can be output. The predetermined time for collecting the gaze vectors may be several seconds, for example, about 1 to 3 seconds.

### Fifth Embodiment

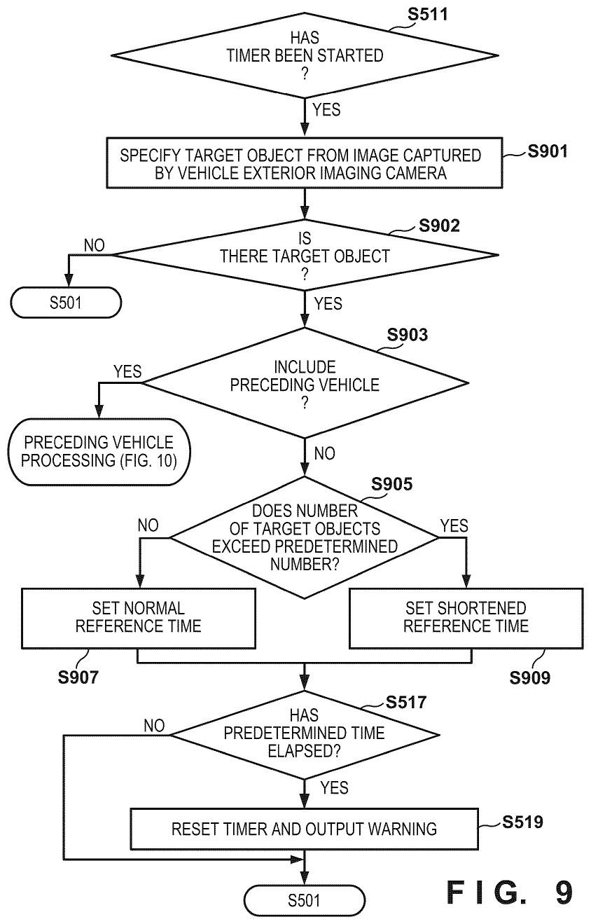

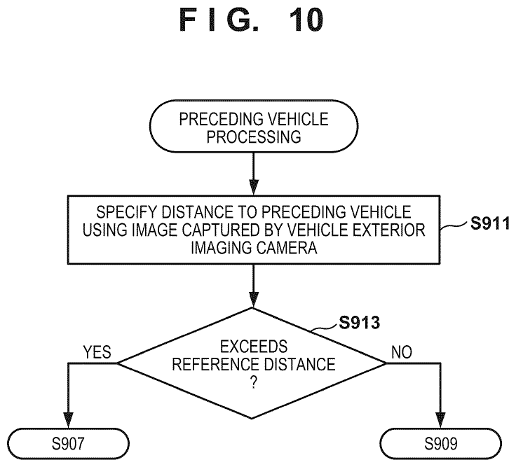

Next, an example in which a mode of a warning is changed according to the presence of a target object such as an obstacle outside a vehicle or a preceding vehicle will be described with reference to an image captured by a vehicle exterior imaging camera 101F. FIGS. 9 and 10 are examples of a procedure executed by a CPU 204 in this case. FIG. 9 illustrates a case where it is determined in step S511 of FIG. 5 that a timer has been started, and processing other than processing in this case is similar to that of the first embodiment. Description of parts similar to those of the first embodiment will be omitted.

In a case where it is determined in step S511 that the timer has been started, the target object is specified from the image captured by the vehicle exterior imaging camera 101F. The specification may be performed by performing pattern recognition or by inputting a feature of the image to a trained model obtained by machine learning using the feature of the image and the target object in the image in advance. As a result, it is determined whether or not the target object has been recognized (S902).

In a case where it is determined that there is no target object, the processing branches to step S501 of FIG. 5. On the other hand, in a case where it is determined that there is a target object, it is determined whether or not the target object includes a preceding vehicle (S903). Whether or not the target object is a preceding vehicle may be determined by, for example, a position, a size, or a distance thereof. In a case where it is determined that there is a preceding vehicle, the processing branches to preceding vehicle processing of FIG. 10, and in a case where it is determined that there is no preceding vehicle, it is determined whether or not the number of target objects in the image exceeds a predetermined number (S905). In a case where it is determined that the number of target objects does not exceed the predetermined number, a normal reference time is set as an expiration time of the timer (S907). The normal reference time may be a time with which it is determined in step S517 of the first embodiment that the timer has expired. On the other hand, in a case where it is determined that the number of target objects exceeds the predetermined number, a shortened reference time shorter than the normal reference time is set as the expiration time of the timer (S907). Thereafter, the processing branches to step S517 to determine the expiration, and if the timer has been expired, step S519 is executed to output a warning.

If it is determined in step S903 that there is a preceding vehicle, a distance to the preceding vehicle is specified in step S911 of FIG. 10. If there is a specified distance at the time of determining the presence of the preceding vehicle, a value thereof may be used. In this example, a height of the vehicle exterior imaging camera 101F from the ground is already set, and a direction of an optical axis thereof is parallel to the ground and an axis of the vehicle in a front-and-rear direction. That is, the vehicle 100 traveling straight travels toward a vanishing point of the image captured by the vehicle exterior imaging camera 101F. In this case, a distance to a point set on the ground can be estimated based on an image height of the image. As a result, the distance to the preceding vehicle can be estimated. Even when an installation position or a direction of the camera does not match the assumption described above, the distance to the preceding vehicle can be estimated by converting a coordinate system if the direction or height of the optical axis with respect to the vehicle is known.

Next, it is determined whether or not the specified distance exceeds a predetermined distance as a reference (S913). If the specified distance exceeds the predetermined distance, the processing branches to step S907 of FIG. 9 to set the normal reference time, and if the specified distance is equal to or shorter than the predetermined distance, the processing branches to step S909 to set the shortened reference time. In a case where the distance to the preceding vehicle is equal to or shorter than the predetermined distance, a predetermined time, that is, a reference time, shortened relative to a case where the distance exceeds the predetermined distance is set.

### Advantageous Effects of Present Embodiment

According to such a procedure, in a case where there are a relatively large number of target objects outside the vehicle and in a case where the distance to the preceding vehicle is relatively short, a time from detection of distraction of the driver to the warning can be shortened relative to other cases. As a result, driver can be alerted at an earlier stage.

In the above embodiment, a monitoring target is an action of the driver to look below the virtual line. However, the present disclosure is not limited thereto, and distraction of the driver may be monitored. That is, for example, in a case where the gaze vector (or the face) of the driver is directed outside a predetermined range in front of the vehicle, the warning may be output.

### Summary of Embodiments

The above-described embodiments are summarized as follows.

1. A driver monitoring apparatus configured to be retrofitted to a vehicle, the driver monitoring apparatus comprising:
a camera configured to capture an image including a driver of a vehicle; an output unit;
at least one memory storing instructions; and
at least one processor that is in communication with the at least one memory and that, when executing the instructions, cooperates with the at least one memory to execute processing, the processing including:
   specifying a gaze direction of the driver from the image captured by the camera;
   determining whether or not the specified gaze direction is continuously below a preset virtual line for more than a predetermined time; and
   outputting, by the output unit, a warning to the driver in a case where it is determined that the gaze direction is continuously below the virtual line for more than the predetermined time.

As a result, it is possible to grasp a situation where the driver is looking downward and to warn the driver.

2. The driver monitoring apparatus according to item 1, further comprising an input unit,
wherein the processing further includes setting the virtual line based on a distance and a height to a lower end of a windshield of the vehicle from a predetermined reference position, the distance and the height being input by the input unit.

As a result, the situation in which the driver is looking downward can be determined based on the set virtual line, so that a state in which the driver is looking downward can be easily and reliably grasped.

3. The driver monitoring apparatus according to item 1,
wherein the processing further includes setting the virtual line based on the specified gaze direction of the driver.

As a result, the virtual line can be set by a simple method.

4. The driver monitoring apparatus according to item 3,
wherein the processing further includes setting the virtual line based on a plurality of the gaze directions different from each other.

As a result, the virtual line can be set by a simple method.

5. The driver monitoring apparatus according to item 1,
wherein the processing further includes specifying a direction in which a face of the driver is directed as the gaze direction.

As a result, the gaze direction of the driver can be specified by a simple method.

6. The driver monitoring apparatus according to item 1,
wherein the processing further includes specifying a direction in which an eye of the driver is directed as the gaze direction.

As a result, the gaze direction of the driver can be specified with higher accuracy, and the driver can be warned with high accuracy.

7. The driver monitoring apparatus according to item 1,
wherein the processing further includes
   further specifying a direction of a face of the driver, and
   outputting, in a case where it is determined that the gaze direction of the driver is continuously below the virtual line for more than the predetermined time and the specified direction of the face is below the virtual line, the warning in a mode different from a case where the direction of the face is not below the virtual line.

As a result, it is possible to detect not only the gaze of the driver but also the direction of the face, and change the mode of the warning in a case where it can be estimated that the driver is distracted.

8. The driver monitoring apparatus according to item 1,
wherein the processing further includes
   further determining whether or not the specified gaze direction is within a certain range for more than a second predetermined time, and
   outputting, by the output unit, the warning also in a case where it is determined that the gaze direction is within the certain range for more than the second predetermined time.

As a result, it is possible to issue the warning not only in a case where the driver is looking downward but also when the gaze is fixed.

9. The driver monitoring apparatus according to item 1, further comprising a second camera configured to capture an image of an area in front of the vehicle,
wherein the processing further includes
   detecting a target object from the image of the area in front of the vehicle, and
   shortening, in a case where the number of detected target objects exceeds a predetermined number, the predetermined time relative to a case where the number of detected target objects does not exceed the predetermined number.

As a result, in a case where there are many obstacles outside the vehicle, it is possible to warn the driver at an earlier timing.

10. The driver monitoring apparatus according to item 9,
wherein the processing further includes
   estimating a distance to a preceding vehicle in a case where the detected target object is the preceding vehicle, and
   shortening, in a case where the distance is equal to or shorter than a predetermined distance, the predetermined time relative to a case where the distance exceeds the predetermined distance.

As a result, in a case where there is a preceding vehicle, the warning can be issued at an earlier timing when the inter-vehicle distance is short.

11. The driver monitoring apparatus according to item 9,
wherein the processing further includes not outputting, by the output unit, the warning in a case where no target object is detected from the image of the area in front of the vehicle.

As a result, the warning can be suppressed from being output if there is no obstacle in the surroundings.

12. The driver monitoring apparatus according to item 1,
wherein the processing further includes
   further specifying a direction of a face of the driver, and
   outputting, by the output unit, the warning in a case where the specified face of the driver is directed outside a predetermined range in front of the vehicle.

As a result, the warning can be issued even in a case where the driver is distracted.

13. The driver monitoring apparatus according to claim 12, further comprising a second camera configured to capture an image of an area in front of the vehicle,
wherein the processing further includes
   determining turning of the vehicle based on the image of the area in front of the vehicle, and
   not outputting, in a case where it is determined that the vehicle is turning and the specified direction of the face of the driver matches a direction in which the vehicle turns, the warning even when the specified face of the driver is directed outside a predetermined range in front of the vehicle.

As a result, even in a case where the driver is distracted, the warning can be suppressed from being output if a direction in which the driver is looking is the turning direction.

14. The driver monitoring apparatus according to item 1,
wherein the driver monitoring apparatus functions as a dashcam configured to record a latest video for a certain time captured by the camera.

As a result, the function as the dashcam can also be provided.

The invention is not limited to the foregoing embodiments, and various variations/changes are possible within the spirit of the invention.

What is claimed is:

1. A driver monitoring apparatus configured to be retrofitted to a vehicle, the driver monitoring apparatus comprising:
a camera configured to capture an image including a driver of a vehicle;
an output unit;
at least one memory storing instructions; and
at least one processor that is in communication with the at least one memory and that, when executing the instructions, cooperates with the at least one memory to execute processing, the processing including:
specifying a gaze direction of the driver from the image captured by the camera;
determining whether or not the specified gaze direction is continuously below a preset virtual line for more than a predetermined time; and
outputting, by the output unit, a warning to the driver in a case where it is determined that the gaze direction is continuously below the virtual line for more than the predetermined time.

2. The driver monitoring apparatus according to claim 1, further comprising an input unit,
wherein the processing further includes setting the virtual line based on a distance and a height to a lower end of a windshield of the vehicle from a predetermined reference position, the distance and the height being input by the input unit.

3. The driver monitoring apparatus according to claim 1,
wherein the processing further includes setting the virtual line based on the specified gaze direction of the driver.

4. The driver monitoring apparatus according to claim 3,
wherein the processing further includes setting the virtual line based on a plurality of the gaze directions different from each other.

5. The driver monitoring apparatus according to claim 1,
wherein the processing further includes specifying a direction in which a face of the driver is directed as the gaze direction.

6. The driver monitoring apparatus according to claim 1,
wherein the processing further includes specifying a direction in which an eye of the driver is directed as the gaze direction.

7. The driver monitoring apparatus according to claim 1,
wherein the processing further includes
further specifying a direction of a face of the driver, and
outputting, in a case where it is determined that the gaze direction of the driver is continuously below the virtual line for more than the predetermined time and the specified direction of the face is below the virtual line, the warning in a mode different from a case where the direction of the face is not below the virtual line.

8. The driver monitoring apparatus according to claim 1,
wherein the processing further includes
further determining whether or not the specified gaze direction is within a certain range for more than a second predetermined time, and
outputting, by the output unit, the warning also in a case where it is determined that the gaze direction is within the certain range for more than the second predetermined time.

9. The driver monitoring apparatus according to claim 1, further comprising a second camera configured to capture an image of an area in front of the vehicle,
wherein the processing further includes
detecting a target object from the image of the area in front of the vehicle, and
shortening, in a case where the number of detected target objects exceeds a predetermined number, the predetermined time relative to a case where the number of detected target objects does not exceed the predetermined number.

10. The driver monitoring apparatus according to claim 9,
wherein the processing further includes
estimating a distance to a preceding vehicle in a case where the detected target object is the preceding vehicle, and
shortening, in a case where the distance is equal to or shorter than a predetermined distance, the predetermined time relative to a case where the distance exceeds the predetermined distance.

11. The driver monitoring apparatus according to claim 9,
wherein the processing further includes not outputting, by the output unit, the warning in a case where no target object is detected from the image of the area in front of the vehicle.

12. The driver monitoring apparatus according to claim 1,
wherein the processing further includes
further specifying a direction of a face of the driver, and
outputting, by the output unit, the warning in a case where the specified face of the driver is directed outside a predetermined range in front of the vehicle.

13. The driver monitoring apparatus according to claim 12, further comprising a second camera configured to capture an image of an area in front of the vehicle,
wherein the processing further includes
determining turning of the vehicle based on the image of the area in front of the vehicle, and
not outputting, in a case where it is determined that the vehicle is turning and the specified direction of the face of the driver matches a direction in which the vehicle turns, the warning even when the specified face of the driver is directed outside a predetermined range in front of the vehicle.

14. The driver monitoring apparatus according to claim 1,
wherein the driver monitoring apparatus functions as a dashcam configured to record a latest video for a certain time captured by the camera.

15. A non-transitory computer-readable storage medium storing a program that causes, when loaded and executed on a computer, the computer to execute processing including:
specifying a gaze direction of a driver from an image captured by a camera;
determining whether or not the specified gaze direction is continuously below a preset virtual line for more than a predetermined time; and
outputting, by an output unit, a warning to the driver in a case where it is determined that the gaze direction is continuously below the virtual line for more than the predetermined time.
